(19) United States
(12) Patent Application Publication
(10) Pub. No.: US 2012/0206948 A1
(43) Pub. Date: Aug. 16, 2012

(54) DEVICE AND METHOD FOR CONVERTING DIRECT CURRENT INTO ALTERNATE CURRENT

(76) Inventors: Giorgio Maldini, Montecchio Emilia (IT); Nicola Buonocunto, Reggio Emilia (IT); Vladislav Patsevitch, Cervignano del Friuli (IT)

(21) Appl. No.: 13/260,433

(22) PCT Filed: Mar. 23, 2010
(86) PCT No.: PCT/IB10/00640

§ 371 Date: May 3, 2012

(30) Foreign Application Priority Data
Mar. 31, 2009 (IT) MO2009A000080

(51) Int. Cl. H02M 7/44

(52) U.S. Cl. 363/97

(57) ABSTRACT

The device for converting direct current into alternate current comprises a multilevel converter associated with at least a source of direct current and a modulation unit having piloting means for piloting the converter for the conversion of the direct current into an alternate output current, in which the modulation unit comprises comparison means for comparing the output current value with a preset positive threshold value and a preset negative threshold value, the piloting means being suitable for piloting the converter with a pulse modulation of the unipolar type in the event of the output current value being above the positive threshold value or below the negative threshold value and with a pulse modulation of the complementary type in the event of the output current value being below the positive threshold value and above the negative threshold value. The method for converting direct current into alternate current comprises a piloting phase of a multilevel converter for the conversion of a direct voltage into an alternate output voltage, a comparison phase of the output current value with a preset positive threshold value and a preset negative threshold value, the piloting phase being suitable for piloting the converter with a pulse modulation of the unipolar type in the event of the output current value being above the positive threshold value or below the negative threshold value and with a pulse modulation of the complementary type in the event of the output current value being below the positive threshold value and above the negative threshold value.

### CROSS-REFERENCE TO RELATED APPLICATIONS

This application is a national phase of PCT International Patent Application No PCT/IB2010/000640, filed Mar. 23, 2010, and Italian Patent Application No MO2009A000080, filed Mar. 31, 2009, in the Italian Patent Office, the disclosures of which are incorporated herein by reference.

### BACKGROUND OF THE INVENTION

1. Field of the Invention

The present invention relates to a device and method for converting direct current into alternate current.

2. Description of the Related Art

The use has been common and known for some time of electronic apparatus so-called “inverters” suitable for converting an input direct current into an output alternate current.

The applications of the inverters are numerous and go, e.g., from the use in UPS units for the conversion of direct current from a supply battery to use in industry for regulating the speed of electric motors or, again, to use in industry to convert the electricity coming from production plants, before introduction into the distribution grid.

A particular type of inverter is the multilevel inverter so-called NPC (Neutral Point Clamped), which is able to supply more than two output power levels so as to generate a wave form as close as possible to the sinusoid shape.

By way of example, FIG. 1 shows the general diagram of a three-phase three-level NPC inverter.

The inverter of FIG. 1 has an input branch composed of two condensers C in series with each other and associated with a source of direct current V_{dc} at a positive voltage terminal V_{dc}+, at a negative voltage terminal V_{dc}− and at a neutral point NP between the two condensers C.

The inverter comprises three electronic power switch units, such as Mosfet, IGBT or similar devices, indicated with the references Sₐ₁-S_{d1}, Sₐ₂-S_{d2} and Sₐ₃-S_{d3}, which are suitably connected together on three branches, one for each phase f1, f2 and f3.

The inverter also comprises three pairs of diodes, indicated in FIG. 1, with the references Dₐ₁ and D_{b1}, Dₐ₂ and D_{b2}, Dₐ₃ and D_{b3} respectively.

With reference to the branch relating to phase f1, e.g., the diodes Dₐ₁ and D_{b1} are arranged in series the one with the other and connect the neutral point NP, respectively, to the connection point between the switches Sₐ₁ and S_{b1} and to the connection point between the switches S_{c1} and S_{d1}.

The diodes Dₐ₂, D_{b2}, Dₐ₃ and D_{b3} are similarly connected with the branches relating to the phases f2 and f3.

By commanding the closing of the switches Sₐ₁-S_{d1}, Sₐ₂S_{d2} and Sₐ₃-S_{d3} it is possible to connect each of the phases to the positive of the voltage V_{dc}+, to the negative of the voltage V_{dc}− and to the node NP (Neutral Point) where the voltage is equal to zero if taken as reference.

The rapid switch of the switches between the possible configurations is done by means of suitable modulation techniques, so as to obtain an alternate output voltage and current on the three phases, starting with the direct current V_{dc}.

One of such modulation techniques is the so-called unipolar modulation of the inverter branches, in which the switches of each branch are on or off according to the variation of a periodical reference voltage.

In particular, with reference by way of example to the branch of the phase f1, the configuration of the switches Sₐ₁, S_{b1}, S_{c1} and S_{d1} is shown below.

During the positive half wave of the reference voltage:
switching of the switch Sₐ₁ at a preset switching frequency;
switch S_{b1} always on;
switch S_{b1} and S_{d1} always off.

During the negative half wave of the reference voltage:
switching of the switch S_{d1} at a preset switching frequency;
switch S_{c1} always on:
switches Sₐ₁ and S_{b1} always off.

The unipolar odulation technique has a number of drawbacks however.

In fact, close to the zero crossing of the output current, meant as the instant in which the ideal current at output on the branch is equal to zero, a distortion on the actual output voltage occurs.

This is due to operation in DCM (Discontinuous Conduction Mode) of the branch current.

In particular, when the average value of the current in the charge inductance is close to cancelling itself out a spurious oscillatory component (ripple) superimposed on it cannot cross the zero, causing an instantaneous variation of the current gradient which flows into the inductance and thus causes a variation of voltage at the heads of the inductance itself.

For greater clarity, and by way of example only, the FIG. 2 and the FIG. 3 show the patterns of voltage and current Vᵤ and Iᵤ respectively coming out of one of the branches in the case of unipolar modulation, from which is clear the presence of the distortions of the signals near the zero crossing.

In particular, FIG. 3 shows the pattern of output current Iᵤ near the zero crossing compared to the pattern of an ideal output current I_{rif}.

The modulation of unipolar type, furthermore, has further drawbacks in the case of the reference voltage and the output current having, at a particular instant or time interval, opposite signs, e.g., in the case of the reference voltage being sinusoid and in advance with respect to the output current Iᵤ.

In this case, at the change of sign of the reference voltage, the current can no longer continue to circulate in the same direction and is forced to zero.

Such patterns of the reference voltage and of the output current Iᵤ are shown by way of example in the FIG. 4, in which the reference current is indicated by the wording U_{rif}.

To overcome the drawbacks of the unipolar modulation, alternative techniques are known, such as the so-called complementary modulation of the inverter branches.

In particular, with reference by way of example to the branch of the phase f1, the configuration of the switches Sₐ₁, S_{b1}, S_{c1} and S_{d1} is shown below.

During the positive half wave of the eference voltage:
switching of the switches Sₐ₁ and S_{c1} at a preset switching frequency;
switch S_{b1} always on;
switch S_{d1} always off.

During the negative half wave of the reference voltage:
switching of the switches S_{d1} and S_{b1} at a preset switching frequency;
switch S_{c1} always on:
switch Sₐ₁ always off.

The complementary modulation technique also has a number of drawbacks however.

In particular, the central switches that switch at the switching frequency are not covered by current and, consequently, when the output current is not near the zero crossing numerous pointless switches are made.

This involves an inevitable increase in energy losses tied to the piloting circuit of the central switches of each branch and additional losses on the diodes tied to the respective dispersion currents.

Furthermore, the correct operation of the inverter requires adequate sizing of the piloting circuit of the central switches.

### SUMMARY OF THE INVENTION

The main aim of the present invention is to provide a device and a method for converting direct current into alternate current that allow to eliminate the disturbances present at the zero crossing of the output current and which, at the same time, allows cutting energy losses to the utmost.

Another object of the present invention is to provide a device and a method for converting direct current into alternate current which allow to overcome the mentioned drawbacks of the known art in the ambit of a simple, rational, easy, effective to use and low cost solution.

The above objects are achieved by the present device for converting direct current into alternate current, comprising at least a multilevel converter associated with at least a source of direct current and at least a modulation unit having piloting means for piloting said converter for the conversion of said direct current into an alternate output current, characterised by the fact that said modulation unit comprises comparison means for comparing said output current value with at least a preset positive threshold value and at least a preset negative threshold value, said piloting means being suitable for piloting said converter with a pulse modulation of the unipolar type in the event of said output current value being above said positive threshold value or below said negative threshold value and with a pulse modulation of the complementary type in the event of said output current value being below said positive threshold value and above said negative threshold value.

The above objects are achieved by the present method for converting direct current into alternate current comprising at least a piloting phase of a multilevel converter for the conversion of a direct voltage into an alternate output voltage, characterised by the fact that it comprises at least a comparison phase of said output current value with at least a preset positive threshold value and at least a preset negative threshold value, said piloting phase being suitable for piloting said converter with a pulse modulation of the unipolar type in the event of said output current value being above said positive threshold value or below said negative threshold value and with a pulse modulation of the complementary type in the event of said output current value being below said positive threshold value and above said negative threshold value.

### BRIEF DESCRIPTION OF THE DRAWINGS

Other characteristics and advantages of the present invention will become more evident from the description of a preferred, but not sole, embodiment of a device and a method for converting direct current into alternate current, illustrated purely as an example but not limited to the annexed drawings in which:

FIG. 5 is a general block diagram of the device according to the invention;

FIG. 6 is a circuit diagram that shows a possible embodiment of a multilevel converter of the device according to the invention;

FIG. 7 is a graph that schematically shows a possible connection between the output current pattern of the device according to the invention and the operation of the device itself;

FIGS. 8 and 9 are graphs and functional diagrams that show the possible configurations of the multilevel converter of the device according to the invention in the case of unipolar modulation;

FIGS. 10 and 11 are graphs and functional diagrams that show the possible configurations of the multilevel converter of the device according to the invention in the case of complementary modulation;

FIG. 12 is a graph that shows the patterns of a reference voltage at input to the modulation unit of the device according to the invention and of the output current of the multilevel converter of the device around the zero crossing of the output current itself;

FIGS. 13 and 14 are graphs that show the patterns of the output current and voltage of the device according to the invention around the zero crossing of the output current itself.

### DETAILED DESCRIPTION OF THE EMBODIMENTS

With particular reference to the figures from 5 to 14, globally indicated by D is a device for converting direct current into alternate current, of the type usable in numerous common-type applications such as, e.g., inside UPS units for the conversion of the direct current generated by a battery, for the conversion of the direct current produced by photovoltaic modules or, again, for regulating the speed of electric motors.

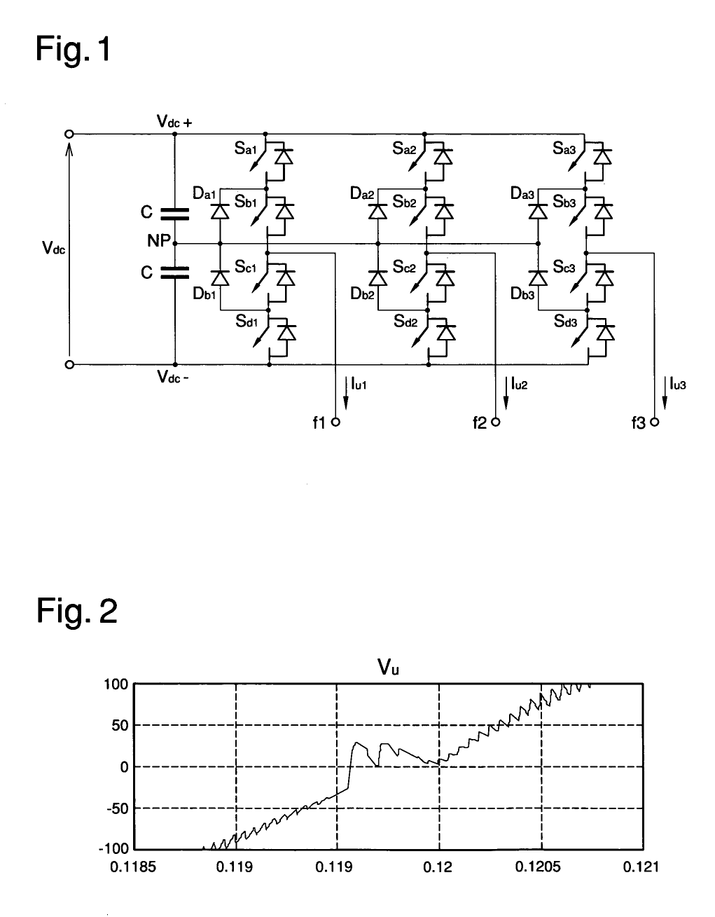

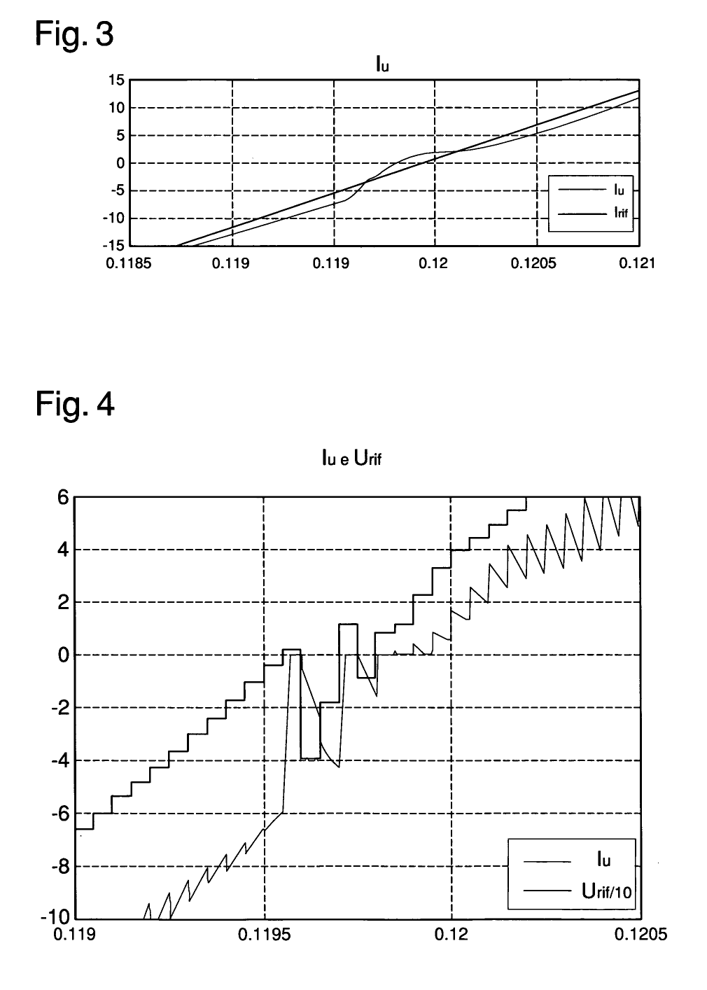

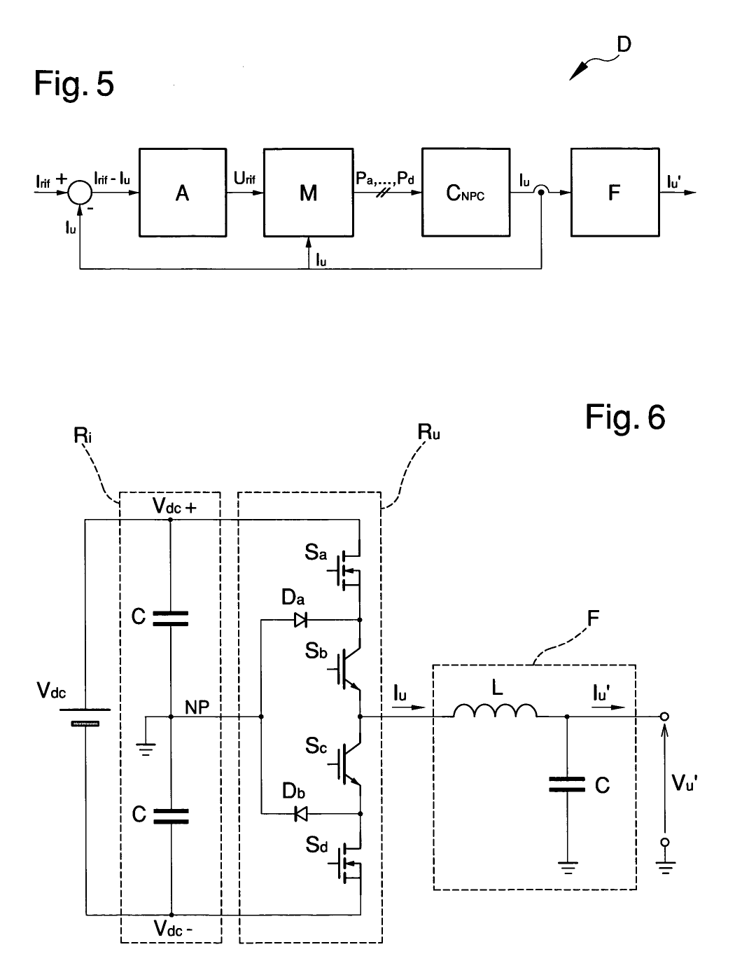

The device D, shown generally and schematically in FIG. 5, comprises a multi-level converter, of the type of an NPC (Neutral Point Clamped) converter or inverter, generically indicated by the reference C_{NPC}.

The device D comprises a modulation unit, generically indicated in FIG. 5 with the reference M, which has means for piloting the converter C_{NPC} for the conversion of a direct current V_{dc} entering the converter itself into an alternate output current Iᵤ.

The device D also comprises a source suitable for generating a reference current I_{rif} to be followed and means for calculating the difference between such reference current I_{rif} and the output current Iᵤ generated by means of the converter C_{NPC}.

In particular, these calculation means are schematised in FIG. 5 by means of a negative feedback control which detects the output current Iᵤ generated by the converter C_{NPC} and subtracts it from the reference current I_{rif} entering the device D.

The device D comprises a current control unit, generically indicated in FIG. 5 by the reference A, arranged downstream of the above calculation means and upstream of the modulation unit M, and which is operatively associated with the modulation unit M and which is provided with means for generating a reference voltage U_{rif}, generated according to the difference calculated between the reference current I_{rif} and the output current Iᵤ.

Advantageously, the piloting means of the modulation unit M are suitable for piloting the converter C_{NPC} according to the reference voltage U_{rif} and the output current Iᵤ.

The device D comprises, moreover, a filtering unit, generically indicated in FIG. 5 by the reference F, which is arranged downstream of the converter C_{NPC} and which is suitable for filtering the output current Iᵤ.

In particular, this filtering unit F can be made with a filter of the LC, LCL type or the like.

With particular reference to the embodiment described and illustrated in FIG. 6, the converter C_{NPC} is of the type of an NPC single-phase inverter with three voltage levels. Different embodiments cannot however be ruled out in which the converter C_{NPC} used is an inverter with more than three levels and/or of the multi-phase type.

In particular, the converter C_{NPC} comprises at least an input branch Rᵢ made up of two condensers C connected in series the one to the other and having a terminal connected to the positive pole V_{dc}+ of the source of direct current V_{dc} and an opposite terminal connected to the negative pole V_{dc}− of the source of direct current V_{dc}.

As an alternative to the source of direct current V_{dc} two independent voltage generators may be used, each being suitable for generating a voltage at the heads of respective condensers C or groups of condensers C.

It is further pointed out that the condensers C shown in the FIG. 6 can be representative of the series and/or of the parallel of several condensers physically made to realise the total necessary capacity.

The connection point between the two condensers C, indicated in FIG. 6 by the reference NP, is the zero-voltage neutral point of the converter C_{NPC}.

The converter C_{NPC} has an output branch Rᵤ comprising a first and a second electronic switch Sₐ and S_{b} connected in series the one to the other between the positive pole V_{dc}+ of the source of direct current V_{dc} and an output terminal, and a third and a fourth electronic switch S_{c} and S_{d} connected in series between the negative pole V_{dc}− of the source of direct current V_{dc} and the output terminal.

Each switch Sₐ, S_{b}, S_{c} and S_{d} is operatively associated with the modulation unit M.

In particular, the piloting means of the modulation unit M comprise means for generating four distinct control signals Pₐ, P_{b}, P_{c}, P_{d}, pulse width modulated (PWM) and suitable for controlling the first, the second, the third and the fourth switches Sₐ, S_{b}, S_{c} and S_{d} respectively.

The use cannot however be ruled out of switch control signals Sₐ, S_{b}, S_{c} and S_{d} modulated by means of different pulse modulation techniques.

Usefully, such switches Sₐ, S_{b}, S_{c} and S_{d} can consist of Mosfet, IGBT or other static commutation devices.

Furthermore, the output branch Rᵤ has a first diode Dₐ and a second diode D_{b}.

The first diode Dₐ has the anode connected to the input branch Rᵢ, at the neutral point NP, and the cathode connected to the connection point between the first switch Sₐ and the second switch S_{b}, while the second diode D_{b} has the cathode connected to the input branch Rᵢ, at the neutral point NP, and the anode connected to the connection point between the third switch S_{c} and the fourth switch S_{d}.

Usefully, the first and the second diode Dₐ and D_{b} and the diodes associated in anti-parallel with the switches Sₐ, S_{b}, S_{b} and S_{d}, not shown in FIG. 6, being of the known type, can be diodes with silicon or SIC (Silicon Carbide) substrate, which permit a reduction of losses due to switching.

It must be pointed out that, notwithstanding the fact that the particular embodiment of the illustrated and described device D envisages the use of a single-phase converter C_{NPC}, having therefore only one output branch Rᵤ, alternative embodiments cannot however be ruled out in which the converter C_{NPC} used is of the multi-phase type and therefore has several output branches Rᵤ, one for each phase of the alternate output current/voltage to be generated.

Advantageously, the modulation unit M comprises comparison means for comparing the output current value Iᵤ of the converter C_{NPC} with a preset positive threshold value Iₚ and with a preset negative threshold value Iₙ.

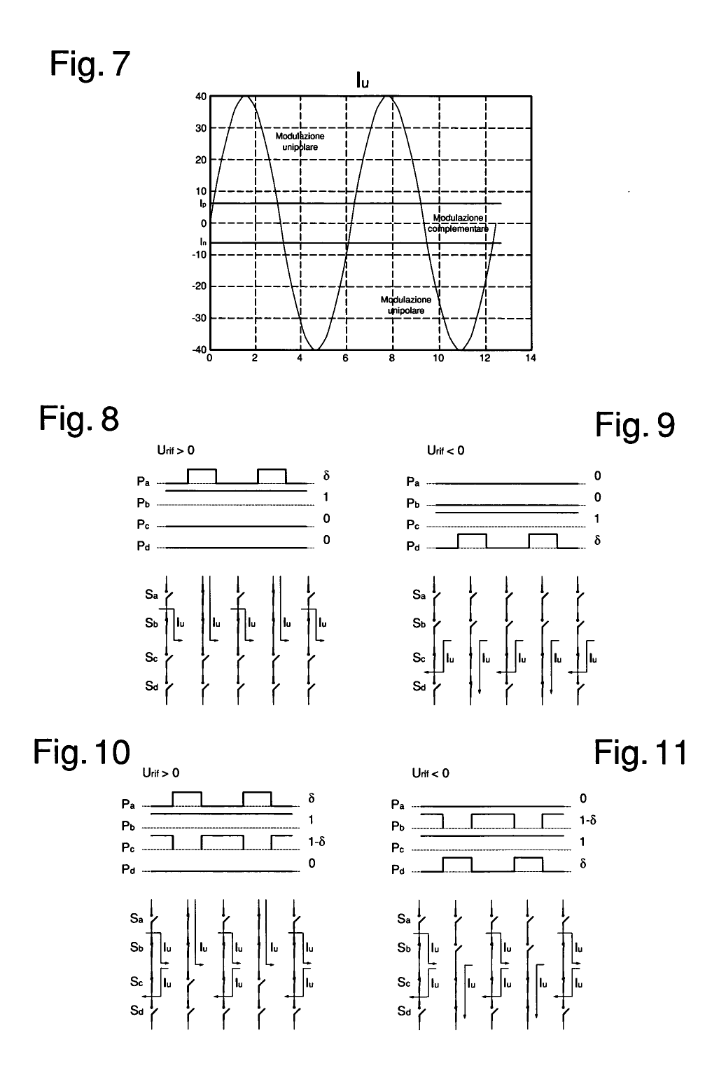

As schematically shown in the graph in FIG. 7, the piloting means of the modulation unit M are suitable for piloting the converter C_{NPC}, in particular the switches Sₐ, S_{b}, S_{c} and S_{d}, with a modulation of unipolar type of the signals Pₐ, P_{b}, P_{c}, P_{d} in the event of the output current value Iᵤ being above the positive threshold value Iₚ or lower than the negative threshold value Iₙ and with a modulation of complementary type of the signals Pₐ, P_{b}, P_{c}, P_{d} in the event of the output current value Iᵤ being below the positive threshold value Iₚ and above the negative threshold value Iₙ.

In detail, in the event of the output current value Iᵤ being above the positive threshold value Iₚ and of the reference voltage U_{rif} being above zero, the piloting means of the modulation unit M are suitable for piloting the converter C_{NPC} with a pulse width modulation of the unipolar type in which, as shown in the FIG. 8:
the first switch Sₐ is periodically switched to a preset frequency by means of the signal Pₐ;
the second switch S_{b} s always on;
the third and fourth switches S_{c} and S_{d} are always off.

In the event of the output current value Iᵤ being below the negative threshold value Iₙ and the reference voltage U_{rif} being lower than zero, the piloting means of the modulation unit M are suitable for piloting the converter C_{NPC} with a width pulse modulation of unipolar type in which, as shown in the FIG. 9:
the fourth switch S_{d} is periodically switched at a preset frequency by means of the signal P_{d};
the third switch S_{c} is always on;
the first and second switches Sₐ and S_{b} are always off.

In the event of the output current value Iᵤ being below the positive threshold value Iₚ and the reference voltage U_{rif} being higher than zero, the piloting means of the modulation unit M are suitable for piloting the converter C_{NPC} with a width pulse modulation of complementary type in which, as shown in the FIG. 10:
the first switch Sₐ and the third switch S_{c} are periodically switched at a preset frequency and in a complementary way to each other by means of the signals Pₐ and P_{c};
the second switch S_{b} is always on;
the fourth switch S_{d} is always off.

In the event of the output current value Iᵤ being above the preset negative threshold value Iₙ and the reference voltage U_{rif} being lower than zero, the piloting means of the modulation unit M are suitable for piloting the converter C_{NPC} with a width pulse modulation of complementary type in which, as shown in the FIG. 11:
the second switch S_{b} and the fourth switch S_{d} are periodically switched at a preset frequency and in a complementary way to each other by means of the signals P_{b} and P_{d};
the third switch S_{c} is always on;
the first switch Sₐ is always off.

The combined use of the unipolar modulation and of the complementary modulation allows, in particular, maintaining the output current Iᵤ in CCM (Continuous Current Mode) around the current zero crossing and ensures the correct operation of the converter C_{NPC} even in the case in which the voltage on the output branch Rᵤ has, in some instants or time periods, an opposite sign with respect to the output current Iᵤ.

This way, the distortions of output voltage Vᵤ generated by the converter C_{NPC} at the zero crossing of the output current Iᵤ are eliminated.

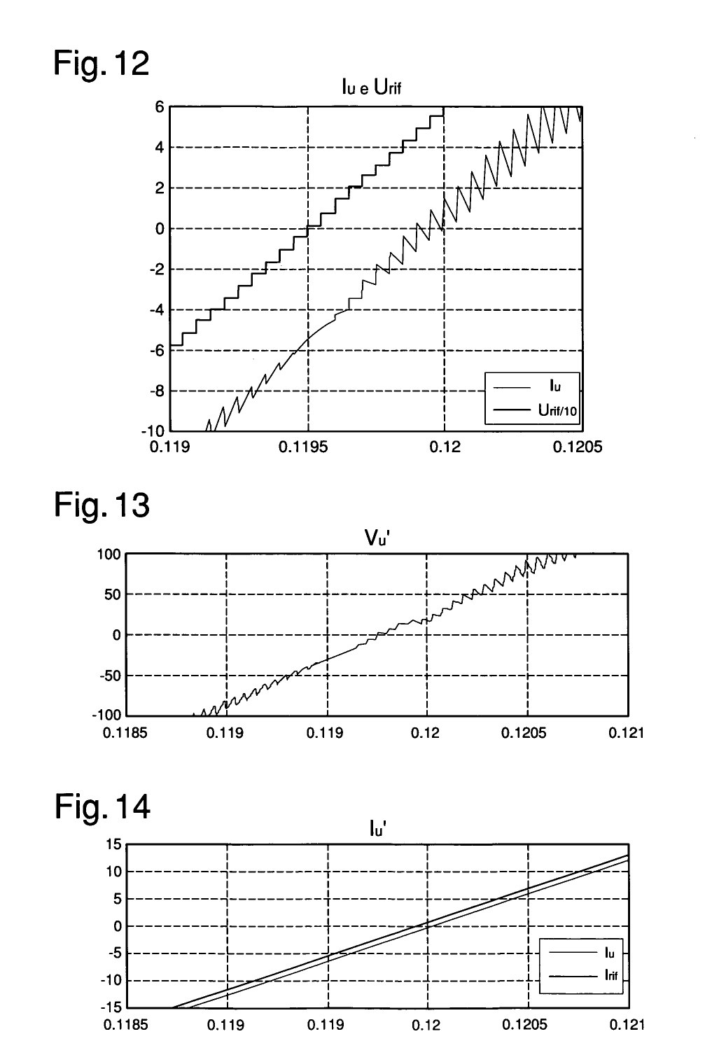

To show the correct operation of the device D, FIG. 12 shows the patterns of the reference voltage U_{rif} (deducted by a factor 10) at input to the modulation unit M and of the output voltage Iᵤ of the converter C_{NPC} around the zero crossing.

Finally, the FIG. 13 and the FIG. 14 show the patterns of the voltage Vᵤ′ and of the output current Iᵤ′ of the device D according to the invention around the zero crossing of the output current and in the case of the charge being the normal power distribution grid.

The method according to the invention includes a phase of comparison of the output current value Iᵤ with a preset positive threshold value Iₚ and with a preset negative threshold value Iₙ and a piloting phase of the converter C_{NPC} for the conversion of the direct current V_{dc} at input into the alternate output current Iᵤ, in which the converter C_{NPC} is piloted with a pulse width modulation of unipolar type when the output current value Iᵤ is above the positive threshold value Iₚ or below the negative threshold value Iₙ and with a pulse width modulation of complementary type when the output current value Iᵤ is below the positive threshold value Iₚ and above the negative threshold value Iₙ.

In particular, the piloting phase comprises a generation phase of the first, second, third and fourth control signal Pₐ, P_{b}, P_{c}, P_{d}, pulse width modulated and suitable for controlling the first, second, third and fourth switch Sₐ, S_{b}, S_{c} and S_{d}.

Advantageously, the method according to the invention comprises a generation phase of the reference signal U_{rif} and the piloting phase of the converter C_{NPC} is performed according to such reference voltage U_{rif} and according to the output current Iᵤ.

In particular, in the event of the output current value Iᵤ being above the positive threshold value Iₚ and the reference voltage U_{rif} being higher than zero, the method envisages the piloting of the converter C_{NPC} with a width pulse modulation of unipolar type in which, as shown in the FIG. 8:
the first switch Sₐ is periodically switched to a preset frequency, by means of the signal Pₐ;
the second switch S_{b} is always on;
the third and fourth switches S_{c} and S_{d} are always off.

In the event of the output current value Iᵤ being below the negative threshold value Iₙ and the reference voltage U_{rif} being lower than zero, the method envisages the piloting of the converter C_{NPC} with a width pulse modulation of unipolar type in which, as shown in the FIG. 9:
the fourth switch S_{d} is periodically switched to a preset frequency, by means of the signal P_{d};
the third switch S_{c} is always on;
the first and second switches Sₐ and S_{b} are always off.

In the event of the output current value Iᵤ being below the positive threshold value Iₚ and the reference voltage U_{rif} being higher than zero, the method envisages the piloting of the converter C_{NPC} with a width pulse modulation of complementary type in which, as shown in the FIG. 10:
the first switch Sₐ and the third switch S_{c} are periodically switched to a preset frequency and in a complementary way to each other, by means of the signals Pₐ and P_{d};
the second switch S_{b} is always on;
the fourth switch S_{d} is always off.

In the event of the output current value Iᵤ being above the preset negative threshold value Iₙ and the reference voltage U_{rif} being lower than zero, the method envisages the piloting of the converter C_{NPC} with a width pulse modulation of complementary type in which, as shown in the FIG. 11:
the second switch S_{b} and the fourth switch S_{d} are periodically switched to a preset frequency and in a complementary way to each other, by means of the signals P_{b} and P_{d};
the third switch S_{c} is always on;
the first switch Sₐ is always off.

Usefully, the method also provides a phase of generation of a reference current I_{rif} and a phase of calculation of the difference between such reference current I_{rif} and the output current Iᵤ.

The reference voltage U_{rif} to be generated at input to the modulation unit M is therefore determined according to the difference calculated between the reference current I_{rif} and the output current Iᵤ.

Finally, the method comprises a filtering phase of the output current Iᵤ by means of the filtering unit F.

It has in point of fact been ascertained how the described invention achieves the proposed objects and in particular, the fact is underlined that the device and the method for converting direct current into alternate current according to the invention, in particular the combined use of the modulation of unipolar type and of the modulation of complementary type, permit eliminating the disturbances present at the zero crossing of the output current and, at the same time, allow reducing to the indispensable utmost the amount of switching of the inverter switches.

Besides a reduction of the disturbances with respect to the modulation of unipolar type only, this also involves a reduction in energy losses compared to complementary type modulation.

In fact, compared to complementary modulation, the described invention permits reducing losses tied to switching by means of the pilot circuit of the central switches of the inverter and, furthermore, permits reducing the sizing requirements of such piloting circuit inasmuch as the central switches are only used for a small percentage of the output current period.

The described invention also allows eliminating the additional losses on the inverter diodes tied to the respective dispersion currents.

Yet another advantage is represented by the fact that the described invention permits a minor distortion of the output voltage in the unipolar modulation area due in particular to the absence of dead times which reduce the useful voltage on the charge, the reference duty cycle being equal.

1. A device (D) for converting direct current into alternate current, comprising at least a multilevel converter (C_{NPC}) associated with at least a source of direct current (V_{dc}), at least a modulation unit (M) having piloting means for piloting said converter (C_{NPC}) for the conversion of said direct current (V_{dc}) into an alternate output current (Iᵤ) and at least a current control unit (A) operatively associated with said modulation unit (M) and having generation means for generating a reference voltage (U_{rif}), wherein said modulation unit (M) comprises comparison means for comparing said output current value (Iᵤ) with at least a preset positive threshold value (Iₚ) and at least a preset negative threshold value (Iₙ), said piloting means being suitable for piloting said converter (C_{NPC}) with a pulse modulation of the unipolar type in the event of said output current value (Iᵤ) being above said positive threshold value (Iₚ) and said reference voltage (U_{rif}) being above zero or in the event of said output current value (Iᵤ) being below said negative threshold value (Iₙ) and said reference voltage (U_{rif}) being lower than zero, and with a pulse modulation of the complementary type in the event of said output current value (Iᵤ) being below said positive threshold value (Iₚ) and said reference voltage (U_{rif}) being above zero and in the event of said output current value (Iᵤ) being above said negative threshold value (Iₙ) and said reference voltage (U_{rif}) being lower than zero.

2. The device (D) according to the claim 1, wherein said converter (C_{NPC}) comprises at least an output branch (Rᵤ) having at least a first and a second electronic switch (Sₐ and S_{b}) associated in series the one with the other between the positive pole (V_{dc}+) of said source of direct current (V_{dc}) and at least an output terminal and having at least a third and a fourth electronic switch (S_{c} and S_{d}) associated in series the one with the other between the negative pole (V_{dc}−) of said source of direct current (V_{dc}) and said output terminal, said electronic switches (Sₐ, S_{b}, S_{c}, S_{d}) being operatively associated with said piloting means of the modulation unit (M).

3. The device (D) according to claim 2, wherein said piloting means comprise generation means for generating at least a first, second, third and fourth control signal (Pₐ, P_{b}, P_{c}, P_{d}) pulse width modulated and suitable for controlling said first, second, third and fourth switch (Sₐ, S_{b}, S_{c}, S_{d}).

4. The device (D) according to claim 2, wherein said converter (C_{NPC}) comprises at least an input branch (Rᵢ) having at least two condensers (C) associated in series the one with the other and having at least a terminal associated with the positive pole (V_{dc}+) of said source of direct current (V_{dc}) and at least an opposite terminal associated with the negative pole (V_{dc}−) of said source of direct current (V_{dc}).

5. The device (D) according to claim 4, wherein said output branch (Rᵤ) comprises at least a first diode (Dₐ) with the anode associated with said input branch (Rᵢ), at a connection point (NP) between said two condensers (C), and with the cathode associated with said output branch (Rᵤ), at a connection point between said first and said second switch (Sₐ and S_{b}), and at least a second diode (D_{b}) with the cathode associated with said input branch (Rᵢ), at said connection point (NP) between said two condensers (C), and with the anode associated with said output branch (Rᵤ), at a connection point between said third and fourth switch (S_{c} and S_{d}).

6. The device (D) according to the claim 5, wherein said connection point (NP) between said condensers (C) is a zero-voltage neutral point.

7. The device (D) according to the claim 2, wherein said converter (C_{NPC}) comprises a plurality of said output branches (Rᵤ).

8. The device (D) according to claim 2, wherein said first, second, third and fourth switches (Sₐ, S_{b}, S_{c}, S_{d}) are of the Mosfet, IGBT type or the like.

9. (canceled)

10. The device (D) according to claim 2, wherein, in the event of said output current value (Iᵤ) being above said positive threshold value (Iₚ) and said reference voltage (U_{rif}) being higher than zero, said piloting means are suitable for piloting said converter (C_{NPC}) with a width pulse width modulation of unipolar type in which:
said first switch (Sₐ) is periodically switched at a preset frequency;
said second switch (S_{b}) is always on;
said third and fourth switches (S_{c} and S_{d}) are always off.

11. The device (D) according to claim 2, wherein, in the event of said output current value (Iᵤ) being below said negative threshold value (Iₙ) and said reference voltage (U_{rif}) being lower than zero, said piloting means are suitable for piloting said converter (C_{NPC}) with a pulse width modulation of unipolar type in which:
said fourth switch (S_{d}) is periodically switched at a preset frequency;
said third switch (S_{c}) is always on;
said first and second switches (Sₐ and S_{b}) are always off.

12. The device (D) according to claim 2, wherein, in the event of said output current value (Iᵤ) being below said positive threshold value (Iₚ) and said reference voltage (U_{rif}) being higher than zero, said piloting means are suitable for piloting said converter (C_{NPC}) with a pulse width modulation of complementary type in which:
said first switch (Sₐ) and said third switch (S_{c}) are periodically switched at a preset frequency and in a complementary way to each other;
said second switch (S_{b}) is always on;
said fourth switch (S_{d}) is always off.

13. The device (D) according to claim 2, wherein in the event of said output current value (Iᵤ) being above said negative threshold value (Iₙ) and said reference voltage (U_{rif}) being lower than zero, said piloting means are suitable for piloting said converter (C_{NPC}) with a pulse width modulation of complementary type in which:
said second switch (S_{b}) and said fourth switch (S_{d}) are periodically switched at a preset frequency and in a complementary way to each other;
said third switch (S_{c}) is always on;
said first switch (Sₐ) is always off.

14. The device (D) according to claim 1, further comprising at least a source of reference current (I_{rif}) and calculation means for calculating the difference between said reference current (I_{rif}) and said output current (Iᵤ).

15. The device (D) according to claim 13, further comprising a current control unit (A) comprising determination means for determining the reference voltage (U_{rif}) to be generated according to the difference calculated between said reference current (I_{rif}) and said output current (Iᵤ).

16. The device (D) according to claim 15, further comprising at least a filtering unit (F) arranged downstream of said converter (C_{NPC}) and suitable for filtering said output current (Iᵤ).

17. The device (D) according to claim 16, wherein said filtering unit (F) comprises at least one between an LC filter, an LCL filter or the like.

18. A method for converting direct current into alternate current, comprising at least a piloting phase of a multilevel converter (C_{NPC}) for the conversion of a direct voltage (V_{dc}) into an alternate output voltage (Iᵤ) and at least a generation phase of a reference voltage (U_{rif}), and at least a comparison phase of said output current value (Iᵤ) with at least a preset positive threshold value (Iₚ) and at least a preset negative threshold value (Iₙ), said piloting phase being suitable for piloting said converter (C_{NPC}) with a pulse modulation of the unipolar type in the event of said output current value (Iᵤ) being above said positive threshold value (Iₚ) and said reference voltage (U_{rif}) being above zero or in the event of said output current value (Iᵤ) being below said negative threshold value (Iₙ) and said reference voltage (U_{rif}) being lower than zero, and with a pulse modulation of the complementary type in the event of said output current value (Iᵤ) being below said positive threshold value (Iₚ) and said reference voltage (U_{rif}) being above zero and in the event of said output current value (Iᵤ) being above said negative threshold value (Iₙ) and said reference voltage (U_{rif}) being lower than zero.

19. The method according to the claim 18, wherein said converter (C_{NPC}) comprises at least an output branch (Rᵤ) having at least a first and a second electronic switch (Sₐ and S_{b}) associated in series the one with the other between the positive pole (V_{d}+) of a source of said direct voltage (V_{dc}) and at least an output terminal, and having at least a third and a fourth electronic switch (S_{c} and S_{d}) associated in series the one with the other between the negative pole (V_{dc}−) of said source of direct voltage (V_{dc}) and said output terminal.

20. The method according to claim 18, wherein said piloting phase comprises a generation phase of at least a first, second, third and fourth control signal (Pₐ, P_{b}, P_{c}, P_{d}), pulse width modulated and suitable for controlling said first, second, third and fourth switch (Sₐ, S_{b}, S_{c}, S_{d}).

21. The method according to claim 19, wherein said converter (C_{NPC}) comprises at least an input branch (Rᵢ) having at least two condensers (C) associated in series the one with the other and having at least a terminal associated with the positive pole (V_{dc}+) of said source of direct voltage (V_{dc}) and at least an opposite terminal associated with the negative pole (V_{dc}−) of said source of direct voltage (V_{dc}).

22. The method according to claim 20, wherein said output branch (Rᵤ) comprises at least a first diode (Dₐ) with the anode associated with said input branch (Rᵢ), at a connection point (NP) between said two condensers (C), and with the cathode associated with said output branch (Rᵤ), at a connection point between said first and second switch (Sₐ and S_{b}), and at least a second diode (D_{b}) with the cathode associated with said input branch (Rᵢ), at said connection point (NP) between said two condensers (C), and with the anode associated with said output branch (Rᵤ), at a connection point between said third and fourth switch (S_{c} and S_{d}).

23. (canceled)

24. The method according to claim 18, wherein, in the event of said output current value (Iᵤ) being above said positive threshold value (Iₚ) and said reference voltage (U_{rif}) being higher than zero, said piloting phase is suitable for piloting said converter (C_{NPC}) with a pulse width modulation of unipolar type in which:
said first switch (Sₐ) is periodically switched to a preset frequency;
said second switch (S_{b}) is always on;
said third and fourth switches (S_{c} and S_{d}) are always off.

25. The method according to claim 18, wherein in the event of said output current value (Iᵤ) being below said negative threshold value (Iₙ) and said reference voltage (U_{rif}) being lower than zero, said piloting phase is suitable for piloting said converter (C_{NPC}) with a pulse width modulation of unipolar type in which:
said fourth switch (S_{d}) is periodically switched to a preset frequency;
said third switch (S_{c}) is always on;
said first and second switches (Sₐ and S_{b}) are always off.

26. The method according to claim 18, wherein in the event of said output current value (Iᵤ) being below said positive threshold value (Iₚ) and said reference voltage (U_{rif}) being higher than zero, said piloting phase is suitable for piloting said converter (C_{NPC}) with a pulse width modulation of complementary type in which:
said first switch (Sₐ) and said third switch (S_{c}) are periodically switched to a preset frequency and in a complementary way to each other;
said second switch (S_{b}) is always on;
said fourth switch (S_{d}) is always off.

27. The method according to claim 18, wherein in the event of said output current value (Iᵤ) being above said negative threshold value (Iₙ) and said reference voltage (U_{rif}) being lower than zero, said piloting phase is suitable for piloting said converter (C_{NPC}) with a pulse width modulation of complementary type in which:
said second switch (S_{b}) and said fourth switch (S_{d}) are periodically switched to a preset frequency and in a complementary way to each other;
said third switch (S_{c}) is always on;
said first switch (Sₐ) is always off.

28. The method according to claim 18, wherein it comprises at least a generation phase of a reference current (I_{rif}) and at least a calculation phase of the difference between said reference current (I_{rif}) and said output current (Iᵤ).

29. The method according to claim 28, comprising at least a determination phase for determining the reference voltage (U_{rif}) to be generated according to the difference calculated between said reference current (I_{rif}) and said output current (Iᵤ).

30. The method according to claim 18, comprising at least a filtering phase of said output current (Iᵤ).
